(19) United States
(12) Patent Application Publication
(10) Pub. No.: US 2012/0067826 A1
(43) Pub. Date: Mar. 22, 2012

(54) FILTRATION SYSTEM

(76) Inventor: Patrick White, Snellville, GA (US)

(21) Appl. No.: 12/883,776

(22) Filed: Sep. 16, 2010

(51) Int. Cl. B01D 29/66; B01D 37/04; B01D 35/16

(52) U.S. Cl. 210/741; 210/108

(57) ABSTRACT

A filtration system and methods to remove solids contained in a fluid is disclosed. In one embodiment a system includes: a housing; a screen filter adapted to remove solids from a fluid, the filter having openings through which fluid, separated from solids, can pass as a filtered fluid and on which solids are captured on a surface of the filter; flow control valves adapted to open and close to control fluid flow; a controller electronically coupled to the flow control valves and adapted to actuate the flow control valves to reverse a fluid flow direction, thereby adapted to push separated solids away from the screen; and a differential pressure switch adapted to monitor a differential pressure developed across the screen as the screen openings are blocked by solids contained within the fluid and communicate a measured differential pressure to the controller to indicate when to actuate the valves.

### FIELD OF THE INVENTION

The technology described herein relates generally to fluid filtration systems. More specifically, this technology relates to a system and associated methods for automatic backwash filtration to remove suspended matter contained in a liquid mass such as water, oil, and various other fluids.

### BACKGROUND OF THE INVENTION

Fluid filtration systems are known in the background art. It is known that filter screens utilized in such filtration systems require cleaning after use over a period of time. Periodic cleaning of a filter screen is required to ensure the efficiency of the filtration system. It is therefore necessary to monitor the filter screen to identify when the screen needs to be cleaned. Leaving a clogged screen in the filtration system can cause damage to the system and prevent efficient operation of the system.

Numerous types of filtration systems for filtering fluids are known in the background art. However, none of the background art provides a system as disclosed herein.

The technology described herein provides for vast improvements over existing technologies which include, for example, filtration systems by Amiad®. This system uses the suction from the liquid mass to create suction and direct that suction onto the screening material via a nozzle. The nozzle is attached to a motor and slides up and down the filter screening material for a predetermined time to clean the screening material. Other filtration systems attach a solenoid to the discharge side of the filter housing and controlled it with a timer so if the operator wants it cleaned every hour for 1 minute that is what will happen whether it needs to be cleaned or not.

Related patents known in the background art include the following: U.S. Pat. No. 6,402,954, issued to O'Keefe, Jr. on Jun. 11, 2002, discloses a method and apparatus for monitoring and cleaning a fluid filter system.

The foregoing patent information reflects the state of the art of which the inventor is aware and is tendered with a view toward discharging the inventor's acknowledged duty of candor in disclosing information that may be pertinent to the patentability of the technology described herein. It is respectfully stipulated, however, that the foregoing patent and other information do not teach or render obvious, singly or when considered in combination, the inventor's claimed invention.

### BRIEF SUMMARY OF THE INVENTION

In various exemplary embodiments, the technology described herein provides a system and associated methods for automatic backwash filtration to remove suspended matter contained in a liquid mass such as water, oil, and various other fluids.

In one exemplary embodiment, the technology described herein provides a filtration system. The filtration system includes: an inlet and an outlet for a fluid; a pump operable to actuate fluid flow of a fluid through the filtration system; a filter housing; a screen filter disposed within the filter housing and adapted to remove suspended solids from the fluid, the screen filter having a plurality of openings through which the fluid, separated from the solids, can pass as a filtered fluid and on which the suspended solids are captured on a surface of the screen filter; a plurality of flow control valves fluidly coupled to the filtration system and each adapted to operatively open and close to control fluid flow in the filtration system; a controller electronically coupled to the plurality of flow control valves and adapted to actuate one or more of the plurality of flow control valves to redirect a fluid flow direction from an outside/in flow direction to an inside/out flow direction, thereby adapted to push separated solids away from the filter screen; and a differential pressure switch electronically coupled to the controller and adapted to monitor a differential pressure developed across the filter screen as a plurality of filter screen openings are blocked by solids contained within the fluid and communicate a measured differential pressure to the controller, thereby to indicate to the controller when to actuate one or more of the plurality of flow control valves to push separated solids away from the filter screen.

It at least one embodiment the screen filter is a stainless steel screen filter.

It at least one embodiment at least one of the flow control valves is an actuated ball valve.

It at least one embodiment, at least one of the flow control valves is a feed valve.

It at least one embodiment, at least one of the flow control valves is a flush valve.

It at least one embodiment, at least one of the flow control valves is a drain valve.

It at least one embodiment, at least one of the flow control valves is a freeze drain valve.

It at least one embodiment, the flow control valves are at least one feed valve, at least one flush valve, at least one drain valve, and at least one freeze drain valve.

The system further can include a plurality of rigid PVC pipes adapted to fluidly couple the inlet, the outlet, the pump, the housing, the screen filter, and the plurality of flow control valves.

It at least one embodiment, the fluid filtered comprises an ambient temperature non flammable liquid with a specific gravity of 1 and viscosity of 1.0020 millipascal seconds.

The system also can include a vacuum breaker fluidly coupled and disposed between the pump and the flush valve.

The system also can include a flush tube disposed within the filter housing and adapted to clean the filter screen.

It at least one embodiment, the controller further includes a flow input switch.

It at least one embodiment, the controller is a programmable logic controller.

In another exemplary embodiment, the technology described herein provides a method to filter a liquid. The method includes: utilizing a filtration system having an inlet and an outlet for a fluid; a pump operable to actuate fluid flow of the fluid through the filtration system; a filter housing; a screen filter disposed within the filter housing, the screen filter having a plurality of openings through which the fluid, separated from the solids, can pass as a filtered fluid and on which the suspended solids are captured on a surface of the screen filter; a plurality of flow control valves fluidly coupled to the filtration system; a controller electronically coupled to the plurality of flow control valves; and a differential pressure switch electronically coupled to the controller; removing suspended solids from the fluid by capturing the suspended solids on the surface of the screen filter; operatively opening and closing the plurality of flow control valves to control fluid flow in the filtration system; actuating, with the controller, one or more of the plurality of flow control valves, redirecting a fluid flow direction from an outside/in flow direction to an inside/out flow direction, thereby pushing separated solids away from the filter screen; monitoring a differential pressure developing across the filter screen as a plurality of filter screen openings are blocked by solids contained within the fluid; and communicating a measured differential pressure to the controller, thereby to indicating to the controller when to actuate one or more of the plurality of flow control valve to push separated solids away from the filter screen.

The method also can include: operating the filtration system in a normal operation mode with the pump on, with the drain valve closed, with the flush valve closed, with the feed valve open, and with the freeze drain valve closed; and controlling the plurality of flow control valves with the controller.

The method further can include: operating the filtration system in a filter fault mode with the pump off, with the drain valve closed, with the flush valve open, with the feed valve open, and with the freeze drain valve closed; and controlling the plurality of flow control valves with the controller.

The method also can include: operating the filtration system in a freeze protection mode with the pump off, with the drain valve open, with the flush valve open, with the feed valve open, and with the freeze drain valve open; and controlling the plurality of flow control valves with the controller.

The method further can include: operating the filtration system in a filter clean mode with the pump on, with the drain valve open, with the flush valve open, with the feed valve closed, and with the freeze drain valve closed; and controlling the plurality of flow control valves with the controller.

Advantageously, the technology described herein provides a device that can automatically backwash while removing suspended solids from media. Also advantageously, the technology described herein provides for a device that can utilize a programmable logic circuit (PLC) to detect problems within the system and make decisions based on a software program. Further advantageously, the technology described herein provides for a device that can shut itself down and save electricity and water, drain piping to prevent freezing issues and turn itself back on based on external conditions such as ambient temperature. Still further advantageously, the technology described herein provides for a device that filters and cleans a liquid mass automatically without any human intervention.

There has thus been outlined, rather broadly, the more important features of the technology in order that the detailed description thereof that follows may be better understood, and in order that the present contribution to the art may be better appreciated. There are additional features of the technology that will be described hereinafter and which will form the subject matter of the claims appended hereto. In this respect, before explaining at least one embodiment of the technology in detail, it is to be understood that the invention is not limited in its application to the details of construction and to the arrangements of the components set forth in the following description or illustrated in the drawings. The technology described herein is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the technology described herein. It is important, therefore, that the claims be regarded as including such equivalent constructions insofar as they do not depart from the spirit and scope of the technology described herein.

Further objects and advantages of the technology described herein will be apparent from the following detailed description of a presently preferred embodiment which is illustrated schematically in the accompanying drawings.

### BRIEF DESCRIPTION OF THE DRAWINGS

The technology described herein is illustrated with reference to the various drawings, in which like reference numbers denote like device components and/or method steps, respectively, and in which:

FIG. 1 is a schematic view of a filtration system, illustrating, in particular, the various system components, according to an embodiment of the technology described herein;

FIG. 2 is a schematic view of the filtration system depicted in FIG. 1, illustrating, in particular, normal system operation, according to an embodiment of the technology described herein;

FIG. 3 is a schematic view of the filtration system depicted in FIG. 1, illustrating, in particular, filter fault mode, according to an embodiment of the technology described herein;

FIG. 4 is a schematic view of the filtration system depicted in FIG. 1, illustrating, in particular, freeze protection mode, according to an embodiment of the technology described herein; and

FIG. 5 is a schematic view of the filtration system depicted in FIG. 1, illustrating, in particular, filter clean mode, according to an embodiment of the technology described herein.

### DETAILED DESCRIPTION OF THE INVENTION

Before describing the disclosed embodiments of this technology in detail, it is to be understood that the technology is not limited in its application to the details of the particular arrangement shown here since the technology described is capable of other embodiments. Also, the terminology used herein is for the purpose of description and not of limitation.

In various exemplary embodiments, the technology described herein provides a system and associated methods for automatic backwash filtration to remove suspended matter contained in a liquid mass such as water, oil, and various other fluids. The filtration system is preferably used for water filtration. However, the system is useful for filtering other media, including, but not limited to, oil, grease, mud, waste water, and sand.

Suspended matter contained in a liquid mass such as water, oil or various other fluids is removed utilizing pressure, a screening material, and centrifugal force. As the suspended material collects on the screening material a pressure drop occurs. A differential pressure (DP) sensor recognizes this pressure drop and thereby sends a signal to a programmable logic controller (PLC) which then sends 110VAC to three valves, one at the top of the filter housing and one on the inlet and outlet side of the housing. This action reverses the liquid mass flow direction from outside/inside to inside/outside the screening material, forcing the suspended matter to dislodge from the screening material and downward out of the filter housing. Once the pressure drop returns to an acceptable range the DP sensor recognizes this and sends a signal to the PLC dropping out the 110VAC to the three valves returning the flow to normal so filtering can began again. These actions all can occur in approximately 9-120 seconds. The filtration system provides for filtering suspended solids media automatically and without any human intervention.

The system and methods disclosed herein, utilize the PLC to monitor the DP and automate this process with a small filter housing. Additionally, cleaning of the screening material is based on differential pressure alone to cycle on and off the cleaning cycle. The filter housing incorporates a top flush tube which allows the housing to clean much better and more quickly. Also with this disclosed filtration system, heavier suspended matter can now be handled without concern of collapsing the screening material.

The filtration system utilizes a screen filter to remove the suspended solids from the fluid. In at least one embodiment, the screen filter is a stainless steel filter. This filtration system can be used on ambient temperature non flammable liquids with a specific gravity of 1 and viscosity of 1.0020 millipascal seconds, by way of example.

The filtration system includes flow control valves, a filter housing, a stainless steel filter screen, ridged PVC piping, and PLC based electronic controls. The fluid is directed into the filter housing via PVC pipe and flows through the stainless steel filter screen, which traps solids, providing a clean fluid returned to the source. The filter housing allows for the redirection of source fluid via actuated ball valves.

In order to carry out the method of filtration, the following steps are utilized. In filtration mode, dirty water flows through the filter screen operating in a depth filtration or outside/in flow direction. When the filter screen openings are blocked by solids, a differential pressure is developed across filter screen. This pressure is monitored by a differential pressure switch which sends an electrical signal to the programmable logic controller (PLC). The controller activates the flow control valves to redirect the water flow direction from outside/in to an inside/out direction. This redirected flow pushes solids away from the outside of filter screen, thus unblocking the screen openings and fluid flow now carries solids to a drain valve which allows solids laden water to be discharged. Ultimately, at the conclusion of these steps, the stainless steel filter screen openings are no longer blocked by solids and the fluid can now flow through screen which allows it to trap additional solids.

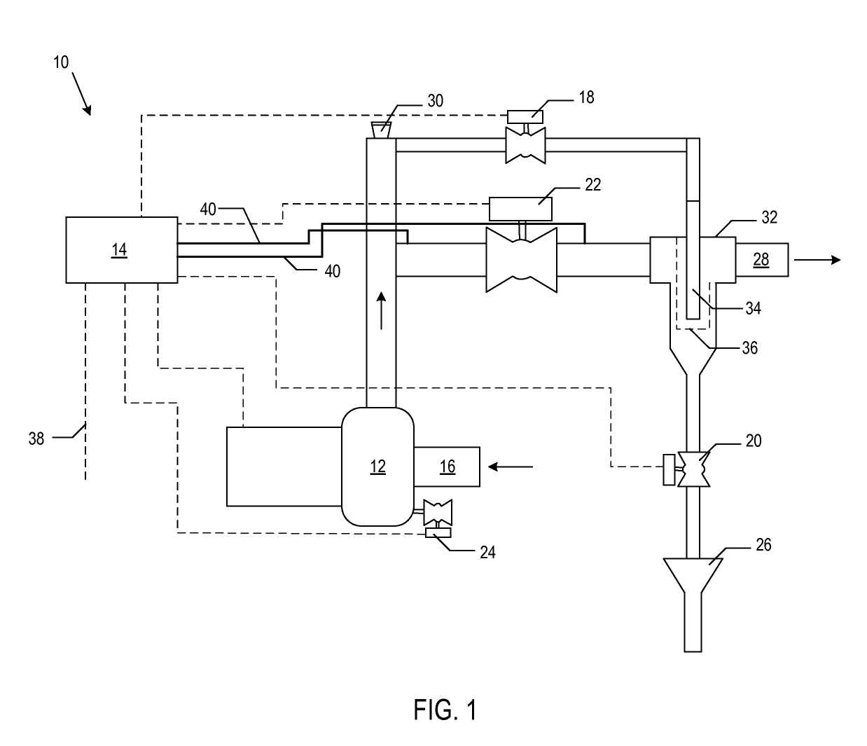

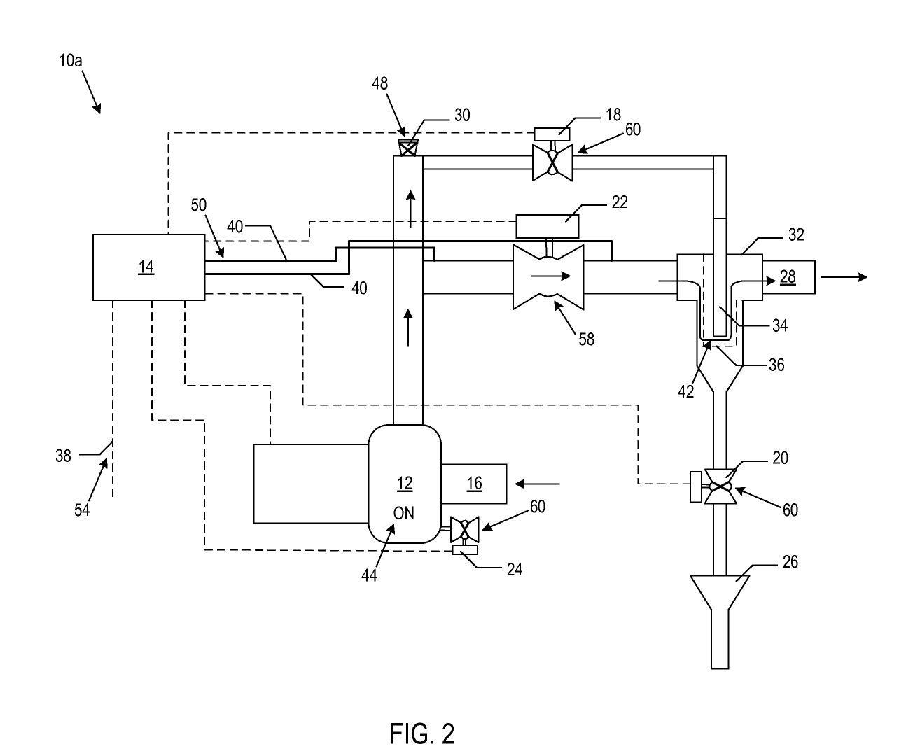

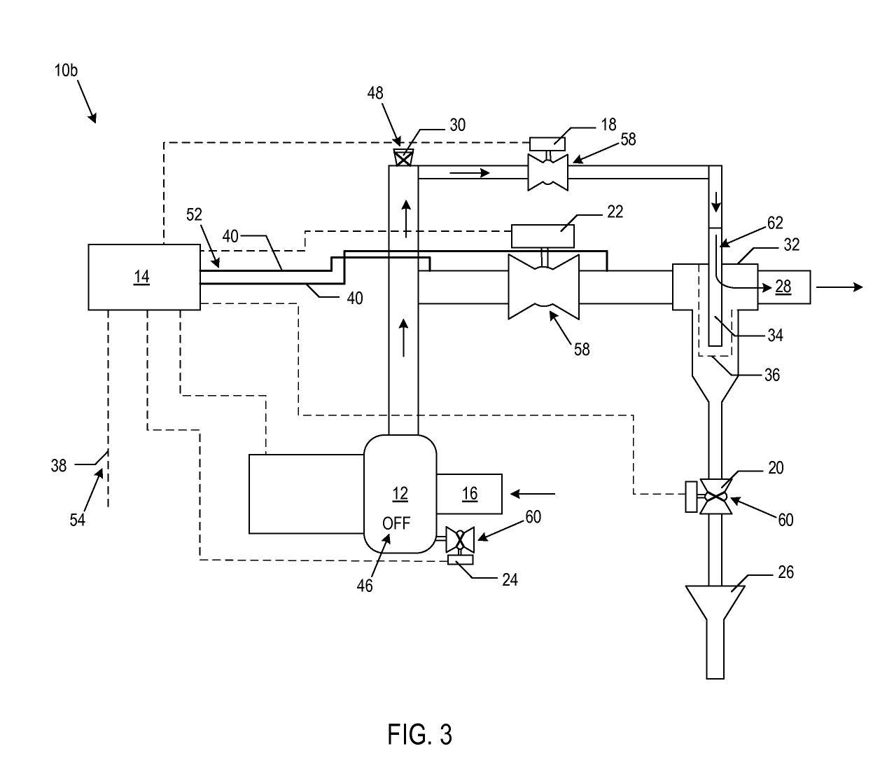

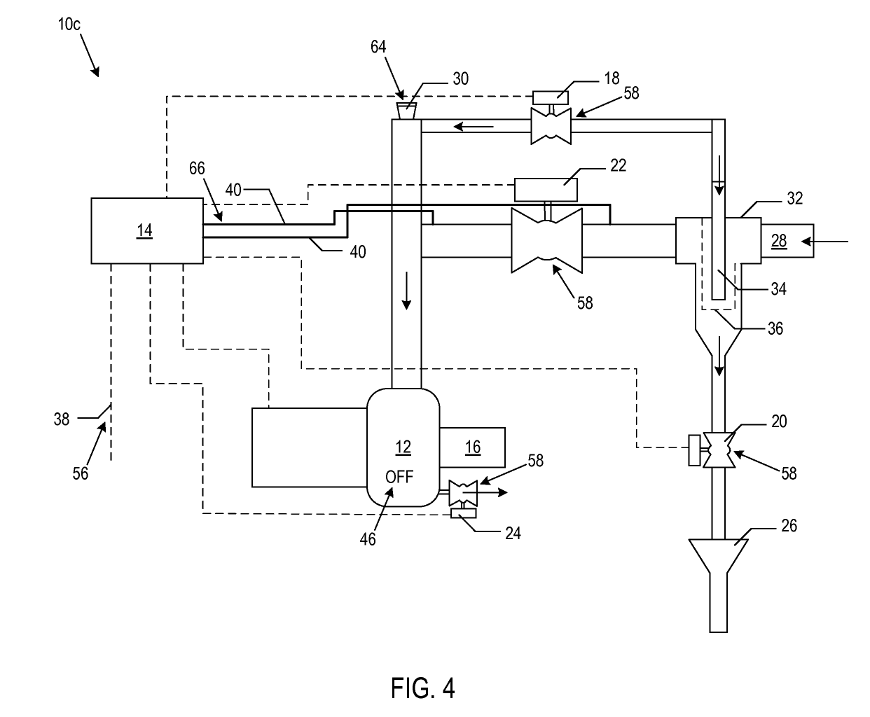

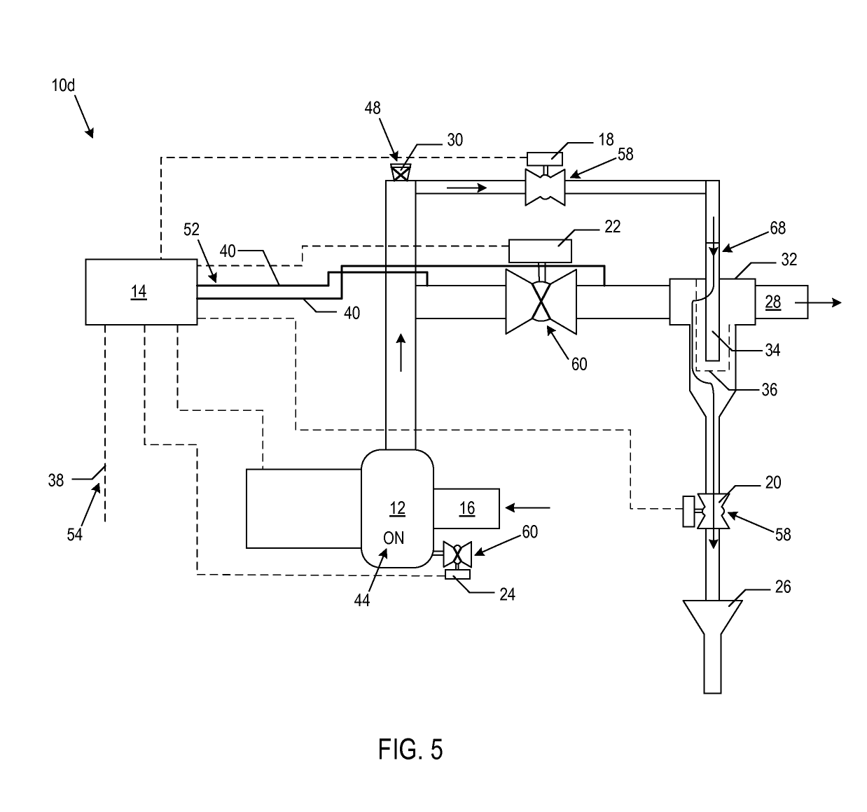

Referring now to the Figures, a filtration system 10 is shown. In FIG. 1, the core system components are depicted. In FIG. 2 normal system operation is shown in system diagram 10a. In FIG. 3, filter fault mode is shown in system diagram 10b. In FIG. 4, freeze protection mode is shown in system diagram 10c. In FIG. 5, filter clean mode is depicted in system diagram 10d.

Referring now to FIG. 1, the core system components are depicted. The filtration system 10 includes a pump 12 to facilitate fluid flow throughout the filtration system 10. Fluid connectivity is established through the use of PVC piping, for example. PVC piping of schedule 80 is used in at least one embodiment. The filtration system 10 includes an inlet 16, outlet 28, and drain 26. The filtration system 10 includes a filter housing 32. Within the filter housing 32, the filter screen 36 is contained, such as a stainless steel filter screen. Directing the fluid into the filter housing 32 and the filter screen 36 is a flush tube 34.

The filtration system 10 includes several flow control valves. The filtration system 10 includes a flush valve 18. A vacuum breaker 30 can be used adjacent to the flush valve 18. The filtration system 10 includes a drain valve 20. The filtration system 10 includes a feed valve 22. The filtration system 10 includes a freeze drain valve 24.

The filtration system 10 includes a controller, such as programmable logic controller (PLC) 14. The PLC 14 utilizes a flow input switch 38. The PLC 14 utilizes a differential pressure input (DP Input) 40 to measure the pressure drop across the screen filter 36. Control wiring is utilized to electronically couple the PLC to the freeze drain valve 24, the drain valve 20, the flush valve 18, and the feed valve 22. When the filter screen openings are blocked by solids, a differential pressure is developed across the filter screen 36. This pressure is monitored by a differential pressure switch 40 which sends an electrical signal to the programmable logic controller (PLC).

Referring now to FIG. 2, normal system operation is shown in system diagram 10a. In this configuration 10a, the pump 12 is in an ON status 44 receiving fluid through inlet 16. The filtered fluid 42 is passed through the filter screen 36 in the filter housing 32 to outlet 28. The vacuum breaker 30 is in a CLOSED status 48. The DP input 40 is at BELOW SET POINT 50. The flow input switch 38 to the PLC 14 is ACTIVE 54. The flush valve 18 is in a CLOSED position 60. The feed valve 22 is in an OPEN position 58. The freeze drain valve 24 is in a CLOSED position 60. The drain valve 20 is in a CLOSED position 60.

Referring now to FIG. 3, filter fault mode is shown in system diagram 10b. In this configuration 10a, the pump 12 is in an OFF status 46. The fluid flow 62 when filter fault is shown through the flush tube 34. The vacuum breaker 30 is in a CLOSED status 48. The DP input 40 is at OVER SET POINT 52. The flow input switch 38 to the PLC 14 is ACTIVE 54. The flush valve 18 is in an OPEN position 58. The feed valve 22 is in an OPEN position 58 permitting fluid flow to the flush tube 34. The freeze drain valve 24 is in a CLOSED position 60. The drain valve 20 is in a CLOSED position 60.

Referring now to FIG. 4, freeze protection mode is shown in system diagram 10c. In this configuration 10c, the pump 12 is in an OFF status 46. The vacuum breaker 30 is in an OPEN status 64. The DP input 40 is at NO DP INPUT 66. The flow input switch 38 to the PLC 14 is OFF 56. The flush valve 18 is in an OPEN position 58. The feed valve 22 is in an OPEN position 58. The freeze drain valve 24 is in an OPEN position 58. The drain valve 20 is in an OPEN position 58 passing to the drain 26.

Referring now to FIG. 5, filter clean mode is depicted in system diagram 10d. In this configuration 10a, the pump 12 is in an ON status 44 receiving fluid through inlet 16. The fluid flow 68 in filter clean mode 10d is shown routing through the flush tube 34 to the drain valve 20. The filtered fluid 42 is passed through the filter screen 36 in the filter housing 32 to outlet 28. The vacuum breaker 30 is in a CLOSED status 48. The DP input 40 is at OVER SET POINT 52. The flow input switch 38 to the PLC 14 is ACTIVE 54. The flush valve 18 is in an OPEN position 58. The feed valve 22 is in a CLOSED position 60. The freeze drain valve 24 is in a CLOSED position 60. The drain valve 20 is in an OPEN position 58 passing to the drain 26.

In use the filtration system can be implemented, by way of example, as follows: Utilizing typical ¾″ schedule 80 PVC piping, connect the filter housing to a liquid mass that needs suspended matter removed. The PVC piping must be connected to the liquid mass in a manner that will allow part of that mass to flow through the filter element and return to the same liquid mass allowing for continuous filtering. Connect the top flush tube to a valve via typical PVC fittings to the supply line. Connect the filter housing inlet to the supply line using typical fittings. Connect the filter housing outlet to the supply. Connect the filter housing discharge to either a drain or a catch basin to remove the suspended matter.

Although this technology has been illustrated and described herein with reference to preferred embodiments and specific examples thereof, it will be readily apparent to those of ordinary skill in the art that other embodiments and examples can perform similar functions and/or achieve like results. All such equivalent embodiments and examples are within the spirit and scope of the technology described herein and are intended to be covered by the following claims.

What is claimed is:

1. A filtration system comprising:
an inlet and an outlet for a fluid;
a pump operable to actuate fluid flow of a fluid through the filtration system;
a filter housing;
a screen filter disposed within the filter housing and adapted to remove suspended solids from the fluid, the screen filter having a plurality of openings through which the fluid, separated from the solids, can pass as a filtered fluid and on which the suspended solids are captured on a surface of the screen filter;
a plurality of flow control valves fluidly coupled to the filtration system and each adapted to operatively open and close to control fluid flow in the filtration system;
a controller electronically coupled to the plurality of flow control valves and adapted to actuate one or more of the plurality of flow control valves to redirect a fluid flow direction from an outside/in flow direction to an inside/out flow direction, thereby adapted to push separated solids away from the filter screen; and
a differential pressure switch electronically coupled to the controller and adapted to monitor a differential pressure developed across the filter screen as a plurality of filter screen openings are blocked by solids contained within the fluid and communicate a measured differential pressure to the controller, thereby to indicate to the controller when to actuate one or more of the plurality of flow control valves to push separated solids away from the filter screen.

2. The filtration system of claim 1, wherein the screen filter comprises a stainless steel screen filter.

3. The filtration system of claim 1, wherein the plurality of flow control valves comprises at least one actuated ball valve.

4. The filtration system of claim 1, wherein the plurality of flow control valves comprises at least one feed valve.

5. The filtration system of claim 1, wherein the plurality of flow control valves comprises at least one flush valve.

6. The filtration system of claim 1, wherein the plurality of flow control valves comprises at least one drain valve.

7. The filtration system of claim 1, wherein the plurality of flow control valves comprises at least one freeze drain valve.

8. The filtration system of claim 1, wherein the plurality of flow control valves comprises: at least one actuated ball valve; at least one feed valve; at least one flush valve; at least one drain valve; and at least one freeze drain valve.

9. The filtration system of claim 1, further comprising:
a plurality of rigid PVC pipes adapted to fluidly couple the inlet, the outlet, the pump, the housing, the screen filter, and the plurality of flow control valves.

10. The filtration system of claim 1, wherein the fluid filtered comprises an ambient temperature non flammable liquid with a specific gravity of 1 and viscosity of 1.0020 millipascal seconds.

11. The filtration system of claim 8, further comprising:
a vacuum breaker fluidly coupled and disposed between the pump and the flush valve.

12. The filtration system of claim 8, further comprising:
a flush tube disposed within the filter housing and adapted to clean the filter screen.

13. The filtration system of claim 1, wherein the controller further comprises a flow input switch.

14. The filtration system of claim 1, wherein the controller comprises a programmable logic controller.

15. A method to filter a liquid, the method comprising:
utilizing a filtration system comprising an inlet and an outlet for a fluid; a pump operable to actuate fluid flow of the fluid through the filtration system; a filter housing; a screen filter disposed within the filter housing, the screen filter having a plurality of openings through which the fluid, separated from the solids, can pass as a filtered fluid and on which the suspended solids are captured on a surface of the screen filter; a plurality of flow control valves fluidly coupled to the filtration system; a controller electronically coupled to the plurality of flow control valves; and a differential pressure switch electronically coupled to the controller;
removing suspended solids from the fluid by capturing the suspended solids on the surface of the screen filter;
operatively opening and closing the plurality of flow control valves to control fluid flow in the filtration system;
actuating, with the controller, one or more of the plurality of flow control valves, redirecting a fluid flow direction from an outside/in flow direction to an inside/out flow direction, thereby pushing separated solids away from the filter screen;
monitoring a differential pressure developing across the filter screen as a plurality of filter screen openings are blocked by solids contained within the fluid; and
communicating a measured differential pressure to the controller, thereby to indicating to the controller when to actuate one or more of the plurality of flow control valve to push separated solids away from the filter screen.

16. The method of claim 15, wherein the plurality of flow control valves comprises:
at least one actuated ball valve; at least one feed valve; at least one flush valve; at least one drain valve; and at least one freeze drain valve.

17. The method of claim 16, further comprising:
operating the filtration system in a normal operation mode with the pump on, with the drain valve closed, with the flush valve closed, with the feed valve open, and with the freeze drain valve closed; and
controlling the plurality of flow control valves with the controller.

18. The method of claim 16, further comprising:
operating the filtration system in a filter fault mode with the pump off, with the drain valve closed, with the flush valve open, with the feed valve open, and with the freeze drain valve closed; and
controlling the plurality of flow control valves with the controller.

19. The method of claim 16, further comprising:
operating the filtration system in a freeze protection mode with the pump off, with the drain valve open, with the flush valve open, with the feed valve open, and with the freeze drain valve open; and
controlling the plurality of flow control valves with the controller.

20. The method of claim 16, further comprising:
operating the filtration system in a filter clean mode with the pump on, with the drain valve open, with the flush valve open, with the feed valve closed, and with the freeze drain valve closed; and
controlling the plurality of flow control valves with the controller.
